(19) United States
(12) Patent Application Publication
(10) Pub. No.: US 2005/0243705 A1
(43) Pub. Date: Nov. 3, 2005

(54) Magneto-optical recording medium with anti-ferromagnetically couple domain-expansion double-layer structure

(75) Inventor: Hans Willem Van Kesteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/519,065

(22) PCT Filed: Jun. 23, 2003
(86) PCT No.: PCT/IB03/02866

§ 371 Date: Dec. 22, 2004

(30) Foreign Application Priority Data
Jul. 5, 2002 (EP) 02077668.8
Nov. 1, 2002 (EP) 02079581.1

(51) Int. Cl. G11B 7/26

(52) U.S. Cl. 369/288

(57) ABSTRACT

A magneto-optical recording medium and manufacturing method for such a medium, wherein a readout expansion layer (EL) consisting of a double- or bi-layer structures with anti-ferromagnetic layers, e.g. GdFeCo or TbFeCo, coupled over a relatively thin non-magnetic metallic layer, e.g. a Ru layer. Under influence of the temperature rise by the focussed spot of a readout radiation beam and the stray field from a storage layer (SL), the magnetization in the double-layer will switch from an anti-parallel to a parallel state. A main advantage of this layer structure is that it offers a symmetric readout response for up and down magnetization in the storage layer (SL) and can in principle be used without external readout field.

The present invention relates to a magneto-optical (MO) recording medium, e.g. data storage medium, comprising a magneto-optical recording layer and an auxiliary magnetic layer, wherein a recorded magnetic domain of the magneto-optical recording layer is magnetically transferred to the auxiliary magnetic layer upon irradiation with a reproducing radiation, e.g. a reproducing light or other suitable radiation, whereby a larger magnetic domain than the recorded magnetic domain of the magneto-optical recording layer can be read back from the auxiliary magnetic layer at the time of reproduction by virtue of the magnetic characteristics of the auxiliary magnetic layer. Furthermore, the present invention relates to a method of manufacturing such an MO recording medium.

MO storage offers the advantage over phase-change recording that marks with a dimension well below the diffraction limit can be written and read out. In MO recording these small bits are written by using Laser Pulsed Magnetic Field Modulation (LP-MFM). In LP-MFM the bit transitions are determined by the switching of the field and the temperature gradient induced by the switching of the laser. For readout of the small crescent shaped marks recorded in this way magnetic super resolution (SR) or domain expansion (DomEx) methods have to be used. These technologies are based on media with several magneto-static or exchange-coupled rare-earth transition-metal (RE-TM) layers. An auxiliary or readout layer on the disk masks adjacent bits during reading so that only the transferred domain from the storage layer is detected (MSR) or expands the transferred domain within the readout spot (DomEx). An advantage of DomEx over MSR is that bits with a dimension well below the diffraction limit can be detected with a similar signal-to-noise ratio (SNR) as bits with a size comparable to the diffraction-limited spot.

AC-MAMMOS (Alternating-Current Magnetic Amplifying Magneto-Optical System) is a DomEx method, proposed by H. Awano et al., Appl. Phys. Lett. Vol. 69, No. 27, pp. 4257-4259, December 1996, which is based on a magneto-statically coupled storage and expansion or readout layer. In an AC-MAMMOS disc, a domain in a storage layer is selectively copied to the readout layer through a non-magnetic intermediate layer, and the copied domain is expanded to a size larger than the diameter of the laser spot by using the external magnetic field. Thus, a large signal is obtained by reproducing the expanded domain. After that, the expanded domain can be removed in the readout layer by applying a reverse external magnetic field.

Domain Wall Displacement Detection (DWDD) is another DomEx method based on an exchange-coupled storage and readout layer, proposed by T. Shiratori et al. in Proc. MORIS'97, J. Magn. Soc. Jpn., 1997, Vol. 22, Supplement No. S2, pp. 47-50. In a DWDD medium, marks recorded in the storage layer are transferred to an auxiliary or displacement layer via an intermediate switching layer as a result of exchange coupling forces. The temperature rises when a reproducing laser spot is irradiated onto a track on the disc. When the switching layer exceeds the Curie temperature, the magnetization is lost, causing the exchange coupling force between each layer to disappear. The exchange coupling force is one of the forces holding the transferred marks in the displacement layer. When it disappears, the domain wall surrounding the recorded marks shifts to a high temperature section which has low domain wall energy, allowing small recorded marks to expand. This allows reading with a laser beam, even if recordings have been made at high density.

The storage and (magnetic super-resolution) readout layers applied in MO storage are based on RE-TM alloys like TbFeCo and GdFeCo. These layers are ferrimagnetic with opposite magnetization directions of the RE and TM sub-lattices. Ferrimagnetism is a form of magnetism occurring in those anti-ferromagnetic materials, in which the microscopic magnetic moments are aligned anti-parallel but are not equal. By suitable choice of the RE element and the composition it possible to design ferrimagnetic substances with specific anisotropy, magnetization and temperature dependence of the magnetic properties. Often, the composition is chosen in such a way that a perpendicular magnetic anisotropy is obtained. By depositing two RE-TM layers on top of each other they can be easily exchange-coupled. The lowest energy state is usually the state in which the sub-lattices in both layers have the same orientation. However, when one layer is RE-rich and the other TM-rich, the net magnetization in the two layers will be opposite. This (direct) exchange coupling of RE-TM layers and the magneto-static coupling of RE-TM layers over a non-magnetic dielectric layer forms the basis of all known super resolution technologies in MO recording.

For ferromagnetic thin-films also anti-ferromagnetic or ferrimagrietic behavior can be obtained by coupling two ferromagnetic thin films over for instance a thin non-magnetic Ru layer. This effect is applied for biasing GMR and TMR elements in sensors and Magnetic Random Access Memories (MAMs). The use of anti-ferromagnetic coupling of ferromagnetic storage layers for hard disc storage is also known and applied in state of the art hard disk drive (HDD) products to increase the magnetic stability of the storage layers. In this case, two ferromagnetic in-plane magnetized Co-alloy films are coupled anti-ferromagnetically over a Ru layer. Document U.S. Pat. No. 5,756,202 discloses an anti-ferromagnetic coupling of two ferromagnetic perpendicularly magnetized Co/Pt multilayer stacks over e.g. a Ru layer, to be used for super resolution and direct-overwrite MO recording.

A number of MAMMOS readout schemes are known. Of these MAMMOS technologies, AC-MAMMOS which applies a modulating readout field has been studied in most detail. In this method, a uniformly perpendicular magnetized readout layer is used. In the center of the readout spot heating leads to an enhancement of the stray field of the storage layer and a reduction of the coercivity of the readout layer. When the bit in the center of the spot has a magnetization direction opposite to the initial readout layer magnetization, a reverse domain is nucleated in the readout layer. A modulated external readout field drives the domain expansion and subsequent collapse. However, this method has a number of disadvantages. During readout an exact timing of the readout field and position of the spot on the data on the disc is required. Furthermore, timing recovery from the data is not possible in the conventional readout scheme and read power and field margins during high resolution readout are small. A recently proposed zero-field MAMMOS technology has been developed in order to solve the aforementioned problems. In this technology, a readout field is no longer required and recording experiments indicate that margins are much larger.

It is an object of the present invention to provide an MO recording medium and manufacturing method, by means of which the readout performance of MO recording media can be improved.

This object is achieved by a MO recording medium as claimed in claim 1 and a manufacturing method as claimed in claim 12.

Accordingly, a alternative improved structure of the MO recording medium is proposed in which an anti-ferromagnetically coupled double-layer structure is applied as readout layer on the MO recording medium. Under influence of the temperature rise by the focussed spot and the temperature dependent exchange or stray field coupling to the storage layer, the magnetization configuration in the double-layer structure will change. This modified magnetization state of the readout layer is detected in the usual way by changes in the polarization sate of the reflected light. A main advantage of this layer structure is that it offers a symmetric readout response for up and down magnetization in the storage layer and with an appropriate choice of the magnetic properties of the layers can be used without an external readout field.

The sub-layers may both consist of a RE-TM material. In particular, the RE-TM material may comprise GdFeCo, GdFe or GdFeAl.

Preferably, the at least two sub-layers may have substantially the same composition and magnetic properties. Thereby, a completely symmetric behavior can be obtained for both magnetization directions, so that they will expand in the same way and also the energy related to the walls in the auxiliary magnetic layer will be the same for both situations.

The antiferromagnetic coupling of the two sublayers is obtained by coupling the sublayers over a non-magnetic metallic coupling layer of a suitable material and thickness. Preferably Ru is used for the coupling layer with a thickness around 0.9 nm because a layer of this material and with this thickness induces a strong antiferromagnetic coupling. Other coupling materials like V, Cr, Mn, Cu, Nb, Mo, Rh, Ta, W, Re, Os, Ir and mixtures thereof can in principle be used as well.

The coupling strength over the non-magnetic coupling layer may be enhanced by choosing appropriate interface layers between the readout sublayers and the coupling layer. For a GdFeCo readout layer, interface layers of for instance Gb, Fe, Co or FeCo can be used. Interface layers can also be used to prevent diffusion of the interlayer into the storage sublayers during recording.

Advantageous improvements of the present invention are defined in the dependent claims.

In the following, the present invention will be described in greater detail on the basis of a preferred embodiment with reference to the accompanying drawings, in which:

FIG. 1 shows a schematic diagram of a MAMMOS readout scheme;

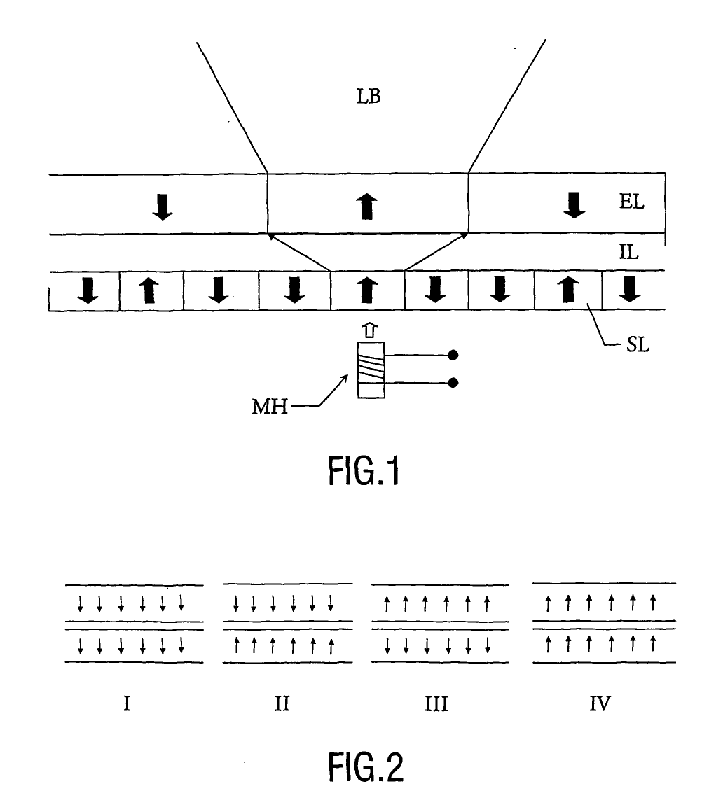

FIG. 2 shows different magnetization states of a double-layer structure;

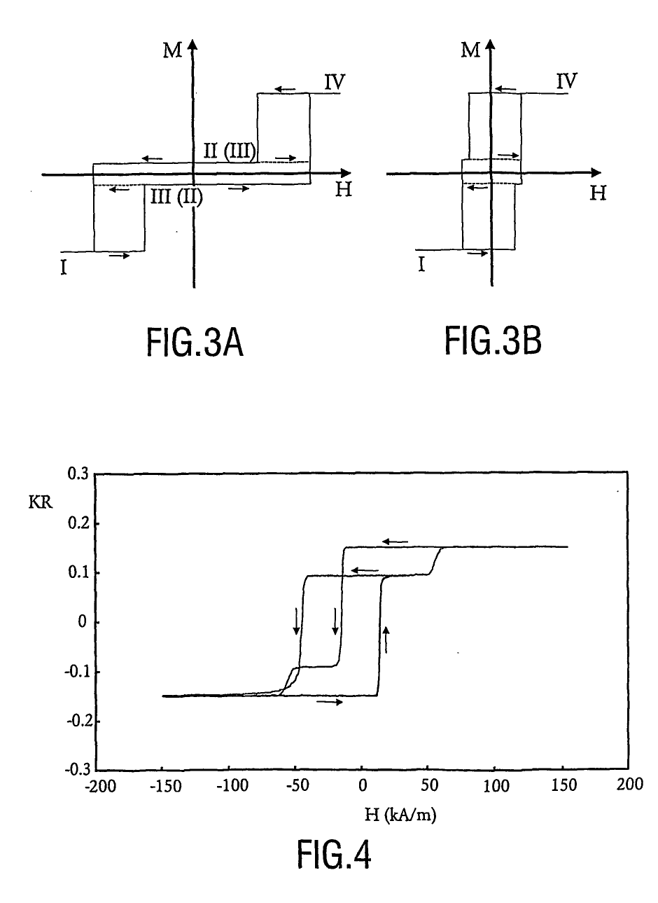

FIGS. 3A and 3B show characteristic diagrams indicating a magnetic hysteresis of the double-layer structure at a large and a small anti-ferromagnetic coupling strength, respectively;

FIG. 4 shows a hysteresis loop of a GdFeCo/Ru/GdFeCo layer stack;

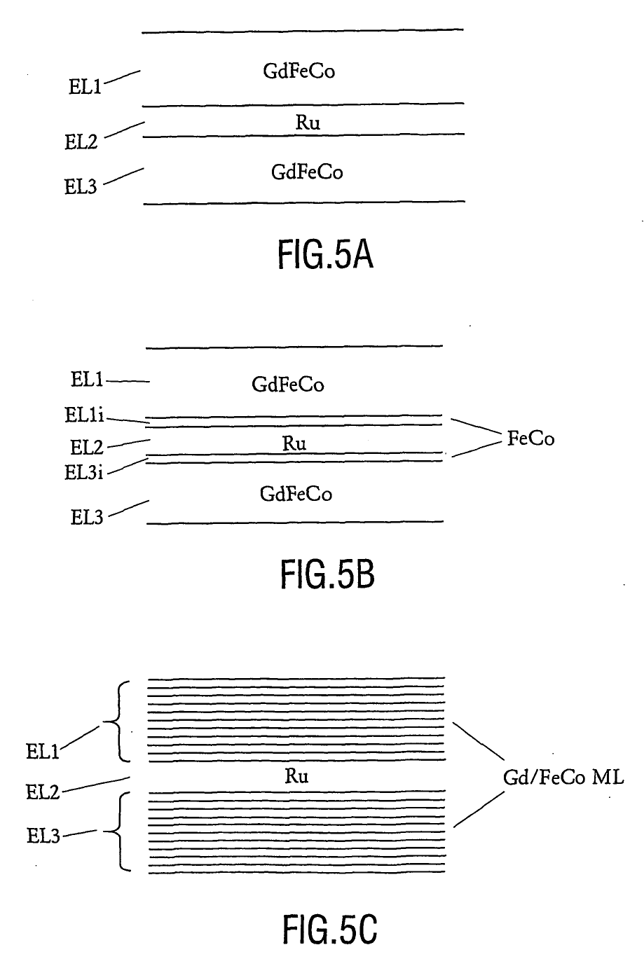

FIGS. 5A, 5B and 5C show schematic structures of a readout layer according to preferred embodiments of the present invention;

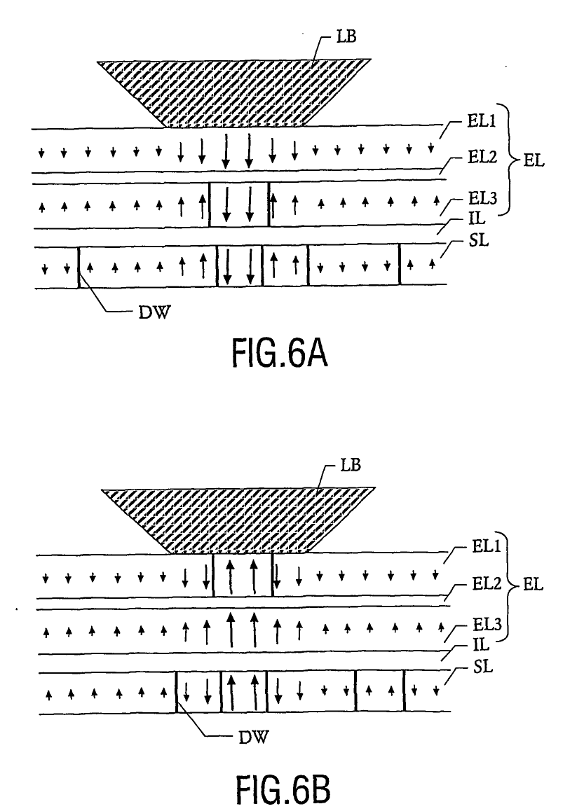

FIGS. 6A and 6B show schematic diagrams indicating a readout process for a first DomEx embodiment with respectively up and down magnetization direction of the copied bits in the storage layer;

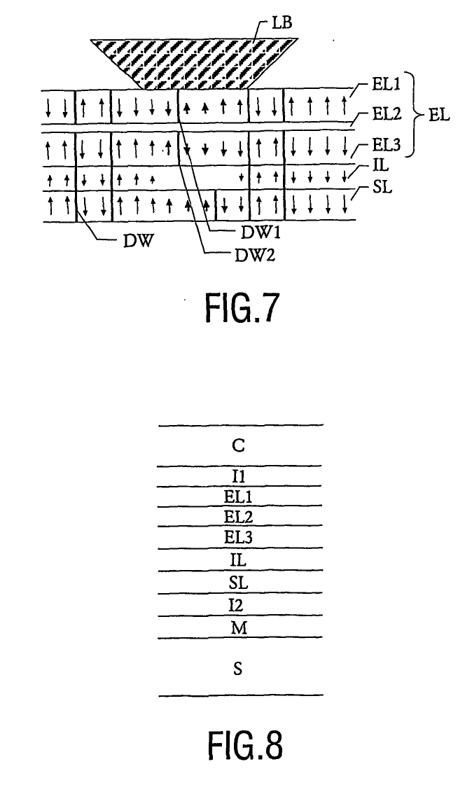

FIG. 7 shows a schematic diagram of a readout process for a second DomEx embodiment; and

FIG. 8 shows a layer structure on a disk for DomEx recording with an anti-ferromagnetically coupled readout double-layer.

FIG. 1 shows a schematic diagram indicating a MAMMOS readout scheme. In a MAMMOS recording medium, a domain indicated by respective arrows in FIG. 1 in a storage layer SL is copied to a readout layer or expansion layer EL through an intermediate layer IL. The copied domain is expanded to a size larger than the diameter of a laser spot of a laser beam LB by using an external magnetic field generated by a magnetic head MH with field coil. The temperature dependent magnetic properties of the storage and expansion layer are chosen in such a way that in the readout process, a small recorded domain is selectively copied to the readout layer. Then, the copied domain is expanded in the readout layer or auxiliary layer EL by the external magnetic field. Thereby, a large signal can be obtained during readout of the expanded domain in the readout layer EL. The expanded domain can be removed in the readout layer EL by applying a reverse external magnetic field. This process is continuously repeated so as to selectively readout the small recorded domains in the storage layer SL.

According to the preferred embodiments, it is proposed to use an anti-ferromagnetically (exchange) coupled double-layer structure for the readout layer. For such a double-layer structure with a perpendicular anisotropy, four magnetization states can exist. FIG. 2 shows these four magnetization states indicated by I, II, III, and IV. The specific state that occurs in a certain external magnetic field will depend on the anti-ferromagnetic coupling strength, the magnetization and thickness of the sublayers, and the magnetic hysteresis. In a sufficiently large external magnetic field, the two layers will orient themselves parallel to the external magnetic field and against the anti-ferromagnetic coupling, as indicated by states I and IV. In case of a small external field, the anti-ferromagnetic coupling dominates, resulting in an anti-parallel state, as indicated by II and III.

FIGS. 3A and 3B show characteristic diagrams of magnetization M vs. external magnetic field H, in which the above magnetization states I to IV are indicated. The diagram in FIG. 3A indicates the situation at a large antiferromagnetic coupling, where the anti-parallel states II and m are obtained for a substantial part of the hysteresis loop. On the other hand, in FIG. 3B, the strength of the exchange coupling is reduced and the hysteresis loop will more and more resemble the loop of a single layer comprising only magnetization states I and IV. The dotted branches are parts of the minor loops that can be reached when the external field is varied between a value where the magnetization of the sublayers is in the direction of the field and a value where the magnetizations are in an anti-parallel alignment. The hysteresis loops indicate that for the situation of FIG. 3A there are only two antiparallel stable states in zero-field. On the other hand for the situation of FIG. 3B all states I to IV are stable in zero-field.

With a non-magnetic coupling layer of for instance Ru, the coupling strength generally does not show a strong temperature dependence. However, with RE-TM adjacent layers, the magnetization and coercivity can be strongly temperature dependent when the compensation temperature is closed to the temperature range of interest for MO recording. For instance, when the compensation temperature is close to room temperature and the Curie temperature above the readout temperature, the shape of the loop can easily change from the shape shown in FIG. 3A to the shape shown in FIG. 3B in between room temperature and the readout temperature.

FIG. 4 shows a hysteresis loop of a 20 nm Si₃N₄/15 nm GdFeCo/0.9 nm Ru/10 nm GdFeCo/20 nm Si₃N₄ layer stack measured in a Kerr hysteresis looptracer at room temperature and a wavelength of 633 nm. In the diagram, the horizontal axis indicates the external field (H) in kA/m and the vertical axis indicates the Kerr rotation (KR) in degrees. The arrows indicate the scanning direction of the field along a certain branch of the hysteresis loop. As can be gathered from FIG. 4, an external magnetic field of an amplitude of more than 60 kA/m is sufficient to ensure stable switching. A minor loop is also depicted in the figure.

FIGS. 5A, B and C show proposed double-layer structures according to preferred embodiments of the present invention. According to FIG. 5A, a synthetic antiferromagnetically coupled double-layer structure of the form GdFeCo/Ru/GdFeCo is proposed as readout layer EL. FIG. 5B shows a synthetic antiferromagnetically coupled double-layer structure of the form GdFeCo/FeCo/Ru/FeCo/GdFeCo where thin FeCo alloy layers (EL1i, EL3i) are added at the interfaces of GdFeCo and Ru to increase the coupling strength. FIG. 5C shows a readout layer embodiment where the sublayers EL1 and EL2 consist of multilayer films of for instance Gd/FeCo or GdFeCo/Pt. The application of multilayers can have advantages for obtaining a higher perpendicular anisotropy or increased Kerr rotation at short wavelengths.

FIG. 6 shows a DomEx layer stack according to the first preferred embodiment, which is irradiated by a laser beam LB. The layer stack comprises an expansion layer EL with a double-layer structure of a first RE-TM layer EL1, a non-magnetic metallic layer EL2 and a second RE-TM layer EL3. Furthermore, the DomEx stack comprises a non-magnetic intermediate layer IL and a storage layer SL. The bold vertical lines indicate domain walls DW between domains of different magnetization. The direction of the arrows in the layer stack indicate the direction of net magnetization, while the thickness or length of the arrows indicate the strength of the net magnetization. It is assumed that the compensation temperature of both parts or sub-layers of the expansion layer EL as well as of the storage layer is close to room temperature. The anti-ferromagnetic coupling, thickness and magnetic properties of the readout sublayers are chosen in such a way that at room temperature only the anti-parallel states are stable in zero-field while at the readout temperature the layers can be switched into the parallel state by a small field. In the readout spot, the magnetization of the bit in the storage layer is increased, especially in the central part. The stray-field of the storage layer on the readout layer becomes that high that it dominates the antiferromagnetic coupling of the readout sublayers. If the coercivity of the readout sublayers EL1, EL3 is sufficiently low, one of them will switch in the direction of the stray field. So both sublayers will than be parallel to the stray field. This bit selection and nucleation mechanism is similar to the mechanism in a conventional MAMMOS medium. However, a main difference is that the stray field of the unswitched readout sublayer due to its temperature dependent magnetization profile, will assist the expansion of the nucleated domain. So no external field is required for that purpose. Depending on the actual composition and thicknesses of the layers in the stack the amount of expansion can vary between a small fraction of the spot (MSR-type readout) and an expansion up to the full spot size (saturated DomEx readout). Another difference is that a completely symmetric behavior for both magnetization directions can be obtained when both RE-TM sub-layers EL1, EL3 of the expansion layer EL have the same composition and magnetic properties. In this case they will expand in the same way and also the energy related to the walls in the expansion layer EL will be the same for both situations, as indicated in FIG. 6B, where the same readout process is shown for an opposite (downward) magnetization of the read domain in the storage layer SL.

When the non-magnetic coupling layer is left out, i.e. when the RE-TM sub-layers EL1, EL3 are provided with a direct RE-TM to RE-TM exchange coupling or with a coupling over a thin RE-TM intermediate layer, it will be very difficult or perhaps even impossible to obtain the anti-parallel coupling with two sub-layers having substantially the same composition. Therefore, it is proposed to apply the thin non-magnetic metallic intermediate layer EL2 for this purpose. This intermediate layer EL2 may be a thin Ru layer which leads to an anti-ferromagnetic coupling when the thickness of the Ru layer has an appropriate value.

FIG. 7 shows a DomEx layer stack according to a second preferred embodiment, which is irradiated by a laser beam LB. The layer stack comprises an expansion layer EL with a double-layer structure of a first RE-TM layer EL1, a non-magnetic metallic layer EL2 and a second RE-TM layer EL3. Furthermore, the DomEx stack comprises a magnetic RE-TM type switching or intermediate layer IL and a storage layer SL. The bold vertical lines indicate domain walls DW between domains of different magnetization. The direction of the arrows in the layer stack indicate the direction of net magnetization, while the thickness or length of the arrows indicate the strength of the net magnetization. It is assumed that the compensation temperature of both parts or sub-layers of the expansion layer EL as well as of the storage layer is above room temperature. Outside the spot, the bits in the storage layer are copied via the exchange coupling with the intermediate or switching layer to the readout sublayer EL3. The anti ferromagnetic coupling strength between the readout sub-layers as well as their magnetization, coercivity, thickness are chosen in such a way that only the anti-parallel states are stable. In the readout spot, the temperature exceeds the Curie temperature of the switching layer so that a non-magnetic area in the switching layer is formed. In this region the walls in the readout layer are no longer hindered and can freely move towards a position with minimal wall energy. Because the wall energy is lower at higher temperature, the walls DW1 and DW2 in the readout sublayers will move to the position of the highest temperature. This leads therefore to a domain expansion process. Because the net magnetization of the two expansion sublayers is small, a fast expansion process can be obtained.

Furthermore, it is no longer necessary to optimize the composition of the expansion layer for a small magnetization at the readout temperature as in the case of a DWDD medium. It is advantageous for a large readout signal to choose the thickness of the sublayers in such a way that the Kerr rotation or ellipticity is largest when the sublayers are in the anti-parallel orientation. Similar to DWDD, a RE-TM control layer can be added between the switching and readout layer to suppress domain wall movement from the rear side of the spot.

FIG. 8 schematically shows the full layer stack on a MO disk according to the second DomEx embodiment. The storage SL, intermediate IL, and readout double layer structure El1, EL2, EL3 are incorporated in an interference stack with dielectric layers I1 and I2 and a metal heat sink layer M. The storage layer SL is exchange coupled in the conventional way with the switching layer IL. For instance, a TbFeCo alloy can be used for the storage layer, a TbFeAl alloy for the switching layer and GdFeAl sub-layers for the displacement layers EL1, El3. The thickness of the two sublayers is chosen substantially the same so that a small overall magnetisation is obtained close to the readout temperature so as to obtain a fast expansion. Ru is used as coupling layer EL2.

It is noted that the present invention is not restricted to the specific layer structure and layer materials given in the above preferred embodiments. Any suitable RE-TM alloy and metal material can be used for the above proposed anti-ferromagnetically coupled double-layer structures of the expansion layer EL or storage layer SL, respectively. The preferred embodiments may thus vary within the scope of the attached claims.

1. A magneto-optical recording medium comprising a magneto-optical recording layer and an auxiliary magnetic layer, wherein a recorded magnetic domain of said magneto-optical recording layer is magnetically transferred to said auxiliary magnetic layer upon irradiation with a reproducing radiation, whereby a larger magnetic domain than said recording magnetic domain of said magneto-optical recording layer can be read back from said auxiliary magnetic layer at the time of reproduction by virtue of the magnetic characteristics of said auxiliary magnetic layer, and wherein said auxiliary magnetic layer comprises a stack including at least two sub-layers which are anti-ferromagnetically coupled through a non-magnetic metallic layer.

2. A recording medium according to claim 1, wherein said sub-layers both consist of a rare-earth transition-metal material.

3. A recording medium according to claim 1, wherein said sub-layers have substantially the same composition.

4. A recording medium according to claim 1, wherein said rare-earth transition-metal material comprises GdFeCo.

5. A recording medium according to claim 1, wherein said rare-earth transition-metal material comprises GdFe.

6. A recording medium according to claim 1, wherein said non-magnetic metallic layer is an Ru layer.

7. A recording medium according to claim 6, wherein said Ru layer has a thickness ranging from 0.5 nm to 1.5 nm.

8. A recording medium according to claim 6, wherein said Ru layer has a thickness of about 0.9 nm.

9. A recording medium according to any one of claim 1, wherein the Kerr rotation or ellipticity of the recording stack has a larger magnitude for the antiparallel than for the parallel orientation of the sublayer magnetizations.

10. A recording medium according to claim 1 wherein the storage layer and the auxiliary layer are coupled over a non-magnetic interlayer.

11. A recording medium according to claim 1 wherein the auxiliary layer and the intermediate layer are coupled at least in a temperature range below the readout temperature by exchange interaction.

12. A method of manufacturing a magneto-optical recording medium comprising a magneto-optical recording layer and an auxiliary magnetic layer, wherein a recorded magnetic domain of said magneto-optical recording layer is magnetically transferred to said auxiliary magnetic layer upon irradiation with a reproducing radiation, whereby a larger magnetic domain than said recording magnetic domain can be read back from said auxiliary magnetic layer at the time of reproduction by virtue of the magnetic characteristics of said auxiliary magnetic layer, said method comprising the step of forming said auxiliary magnetic layer by generating at least two sub-layers which are anti-ferromagnetically coupled through a non-magnetic metallic layer.
